(19) United States
(12) Patent Application Publication
(10) Pub. No.: US 2006/0255160 A1
(43) Pub. Date: Nov. 16, 2006

(54) Memory card, the fabrication thereof and a mobile phone apparatus having a memory card

(76) Inventor: Otto Winkler, Hebertsfelden (DE)

Correspondence Address: SLATER & MATSIL LLP, 17950 PRESTON ROAD, SUITE 1000, DALLAS, TX, 75252, US

(21) Appl. No.: 11/129,208

(22) Filed: May 13, 2005

(51) Int. Cl. H04B 1/38

(52) U.S. Cl. 235/492; 455/558

(57) ABSTRACT

A memory card (1) includes a multiplicity of leads (8), one or more contact elements (9) and a chip (12). The chip (12) is coupled to at least a subset of the leads (8) and has a first contact (13) and a second contact (14). The memory card (1) further includes an antenna (15) placed on the leads (8). The antenna (15) is electrically isolated from the leads (8). The antenna (15) has a first end (16) and a second end (17) and at least one loop. The antenna (15) is configured to one of receive and send electromagnetic waves. The first contact (13) of the chip (12) is coupled to the first end (16) of the antenna (15) and the second contact (14) of the chip (12) is coupled to the second end (17) of the antenna (15). The leads (8) and the chip (12) and the antenna (15) are molded and a surface of the contact elements (9) is exposed.

### TECHNICAL FIELD

The present invention relates to a memory card having the functionality for data transmission between the memory card and a suited reader/writer device effected through different modes.

### BACKGROUND

There are two main applications for today's memory cards. One application focuses on the use of a memory card as a mass storage medium. Memory cards like the Multi Media Card and the SD card can have a memory with a capacity of more than 1 Gigabyte for digital data storage. Such memory cards are typically used in digital cameras to store pictures or in portable music players. For the transmission of data between a suited reader/writer device and the memory card, the memory card is supplied with electrical contacts to allow direct electrical contact to the reader/writer device. These memory cards are mainly constructed with a printed circuit board with multi-chips such as a controller chip, one or more memory dies, passive components and other applicable devices mounted to it. All the components of such a memory card are commonly integrated in a minimum of one plastic cover. With increasing market volume the production process will be driven into a fast and low-cost assembly process of the memory cards.

Another application focuses on the use of a memory card as a smart card. These smart cards have typically the size of a credit card and a relative small capacity for digital data storage. Smart cards have an on-board microcomputer including a memory and processing capability for effecting data transmission to and from a suited reader/writer device and data storage. Smart cards can have electrical contacts for effecting direct electrical contact to a suited reader/writer device for data transmission, or they can have an antenna for non-contact data transmission between the smart card and a suited reader/writer device that has a similar antenna. U.S. Pat. No. 5,206,495, which is incorporated herein by reference, discloses a chip card that can be accessed via contacts or in contact-free fashion so that the chip card can be utilized in either contact card readers or contact-free card readers. Smart cards configured for the transmission of data in non-contact mode are, for example, suited for the transmission of authentication data thereby enabling keyless entry. Typically, the process of fabricating a smart card having non-contact data transmission capability includes the fabrication of the card body, wherein the antenna is laminated between two plastic covers, the insertion of a chip into a cavity of the card body, and the connection of the antenna to the chip.

What is desired is a memory card that has both the functionality of a mass storage medium and the capability to exchange data with a suited card reader device through both contact and non-contact mode. Additionally, it is desired that the fabrication process of the memory card is a fast and low-cost process.

### SUMMARY OF THE INVENTION

In one aspect, the invention provides a memory card and a fast and low-cost process for the fabrication of the memory card, wherein the memory card has the functionality of a mass storage medium and the capability to exchange data with a suited card reader device through one of a non-contact mode and a contact mode.

One embodiment of the present invention provides a method of fabricating a memory card including the step of providing a leadframe, the leadframe having a frame, a multiplicity of leads that are coupled to the frame and one or more contact elements. The method further includes the step of providing a chip having a first contact and a second contact, and placing the chip onto the leadframe. The method further includes the steps of providing an antenna having at least one loop and being configured to one of receive and send electromagnetic waves. The antenna has a first end and a second end and is placed onto the leads of the leadframe thereby electrically insulating the antenna from the leads. The method further includes the steps of connecting the first contact of the chip to the first end of the antenna and connecting the second contact of the chip to the second end of the antenna, injection molding of the leadframe, the chip, and the antenna, removing the frame from the leadframe and exposing a surface of the contact elements.

In another embodiment of the present invention, the step of providing a leadframe includes providing the leadframe having the frame having a first edge, a second edge, a third edge and a fourth edge, wherein the second edge and the fourth edge of the frame are longer than the first edge and the third edge of the frame.

In another embodiment of the present invention, the step of providing a leadframe includes providing the leadframe having the frame and having the one or more contact pads, which are situated in proximity to the first edge of the frame.

In another embodiment of the present invention, the step of providing a leadframe includes providing the leadframe having the frame, having the one or more contact pads which have a first end and a second end, the first end of the one or more contact pads coupled to the first edge of the frame and the second end of the one or more contact pads coupled to at least a subset of the leads.

In another embodiment of the present invention, the step of placing the antenna onto the leads of the leadframe includes placing the antenna onto the leads between the chip and at least one of the second edge, the third edge and the fourth edge of the frame.

In another embodiment of the present invention, the step of providing a chip includes the steps of providing a chip that has further contacts and connecting at least a subset of the further contacts of the chip to at least a subset of the leads. Connecting of at least a subset of the further contacts of the chip to at least a subset of the leads of the leadframe may be performed utilizing a wire bonding technique.

In another embodiment of the present invention, the method of fabricating a memory card further includes the steps of providing another chip having contacts, placing the other chip onto the leadframe, connecting at least a subset of the contacts of the other chip to at least a subset of the leads and connecting the chip and the other chip for data transmission between the chip and the other chip. Connecting of at least a subset of the contacts of the other chip to at least a subset of the leads and connecting the chip and the other chip for data transmission between the chip and the other chip may be performed through a wire bonding technique.

In another embodiment of the present invention, the step of providing a chip includes providing a chip being configured as a controller chip to perform access to the other chip for data to be applied to the contact elements or retrieved from the contact elements and to perform access to the antenna for one of sending and receiving of electromagnetic waves through the antenna.

In another embodiment of the present invention, the step of providing another chip includes providing another chip being configured as a memory chip to perform digital data storage. The memory chip preferably includes an array of non-volatile and erasable memory cells and the memory chip preferably has a capacity for digital data storage of at least one Gigabyte.

In another embodiment of the present invention the leadframe is made of metal, such as copper.

In another embodiment of the present invention the antenna includes at least three loops. For example, the antenna can include three to eight loops.

In another embodiment of the present invention, the step of injection molding includes placing the leadframe, the antenna, the chip and the other chip into a molding cavity, then injection molding the leadframe, the antenna, the chip and the other chip with resin, and then removing the molded package from the molded cavity.

A further aspect of the present invention provides a memory card including a multiplicity of leads, one or more contact elements and a chip connected to at least a subset of the leads. The chip has a first contact and a second contact. An antenna is placed on the leads. The antenna is electrically isolated from the leads. The antenna has a first end, a second end and at least one loop and is configured to one of receive and send electromagnetic waves. The first contact of the chip is coupled to the first end of the antenna and the second contact of the chip is coupled to the second end of the antenna. The leads and the chip and the antenna are molded and the surface of the contact elements is exposed.

In another embodiment of the present invention, the memory card has a first edge, a second edge, a third edge, a fourth edge and a fifth edge.

In another embodiment of the present invention, the one or more contact elements of the memory card are situated in proximity to the first edge of the memory card.

In another embodiment of the present invention, the antenna of the memory card is placed on the leads between the chip and the second edge, the third edge and the fourth edge of the memory card.

In another embodiment of the present invention, the chip of the memory card has further contacts, at least a subset of the further contacts being connected to at least a subset of the leads.

In another embodiment of the present invention, the memory card further comprises another chip being connected to at least a subset of the leads and the other chip having contacts, wherein at least a subset of the contacts of the other chip are connected to at least a subset of the leads, and wherein the chip and the other chip are connected for data transmission between the chip and the other chip.

In another embodiment of the present invention, the chip of the memory card is configured as a controller chip to perform access to the other chip for data to be applied to the contact elements or retrieved from the contact elements and to perform access to the antenna for one of sending and receiving electromagnetic waves through the antenna.

In another embodiment of the present invention, the other chip of the memory card is configured as a memory chip to perform digital data storage. The memory chip may include an array of non-volatile and erasable memory cells to perform digital data storage and the memory chip may have a capacity for digital data storage of at least one Gigabyte.

In another embodiment of the present invention, the leads of the memory card are made of metal, such as copper.

In another embodiment of the present invention the antenna of the memory card has at least three loops. For example, the antenna of the memory card can have three to eight loops.

In another embodiment of the present invention, the antenna and the chip are designed for one of sending and receiving of an electromagnetic wave having a carrier frequency of 13.56 MHz.

Another aspect of the present invention provides a mobile phone apparatus having the memory card according to one embodiment of the invention. The memory card is configured to perform contactless transmission of data between a reader/writer device and the memory card. The memory card is configured to perform data transmission between the mobile phone apparatus and the memory card.

In another embodiment of the present invention, the memory card of the mobile phone apparatus is configured to perform contactless transmission of data between the reader/writer device and the memory card through one of sending and receiving electromagnetic waves.

In another embodiment of the present invention, the memory card of the mobile phone apparatus includes an identifier and is configured to perform contactless transmission of authentication data between the reader/writer device and the memory card through one of sending and receiving electromagnetic waves.

In another embodiment of the present invention, the memory card of the mobile phone apparatus includes a processor configured to encrypt and decrypt data. The memory card is configured to perform contactless transmission of encrypted data between the reader/writer device and the memory card through one of sending and receiving electromagnetic waves.

### DESCRIPTION OF THE DRAWINGS

For a more complete understanding of the present invention, and the advantages thereof, reference is now made to the following descriptions taken in conjunction with the accompanying drawing, in which:

FIG. 1 shows a plan view of a top surface of a memory card according to one embodiment of the invention;

FIG. 2 shows a plan view of a bottom surface of a memory card according to one embodiment of the invention;

FIG. 3 shows schematically a plan view of a memory card according to one embodiment of the invention during a stage of the fabrication;

FIG. 4 shows a schematic of a process flow for fabricating a memory card according to one embodiment of the invention; and

FIG. 5 depicts a preferred application of the memory card according to one embodiment of the invention.

The following list of reference symbols can be used in conjunction with the figures:
1 Memory card 16 First end of antenna
2 Leadframe 17 Second end of antenna
3 Frame 18 Further contacts
4 First edge of frame 19 Chip
5 Second edge of frame 20 Contacts
6 Third edge of frame 21 First edge of memory card
7 Fourth edge of frame 22 Second edge of memory card
8 Leads 23 Third edge of memory card
9 Contact elements 24 Fourth edge of memory card
10 First end of contact elements 25 Mobile phone
11 Second end of contact elements 26 Reader/writer device
12 Chip 27 Wire leads
13 First contact 28 Fifth edge of memory card
14 Second contact 29 Mobile phone display
15 Antenna 30 Mobile phone keyboard

### DETAILED DESCRIPTION OF ILLUSTRATIVE EMBODIMENTS

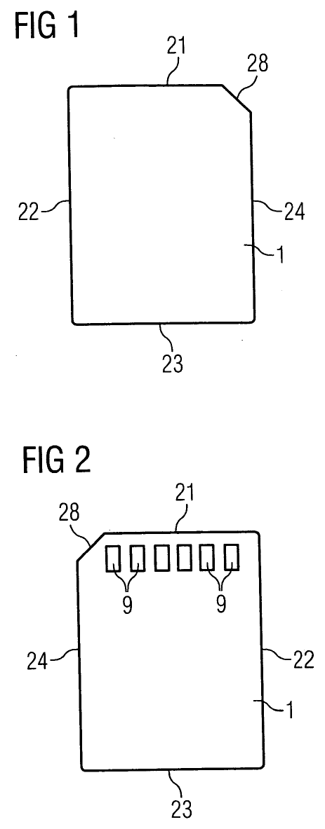

FIG. 1 shows a plan view of a top surface of a memory card 1 according to one embodiment of the present invention. The top surface is made of resin resulting from the molding process at a stage of the fabrication process of the memory card 1. Alternatively the resin could be coated with a protective layer deposited during another fabrication step. The memory card 1 has a first edge 21, a second edge 22, a third edge 23, a fourth edge 24 and a fifth edge 28, that form a pentagon. The corners of the memory card 1 may be rounded off.

In the embodiment, the memory card 1 has the form of a rectangle with a chamfered corner. This specific form facilitates the correct insertion into a suited card reader for a user. The physical dimensions of the memory card 1, the length, the width, the thickness and others may be chosen to comply with standardized formats of multiple kinds of standard memory cards. The outer dimensions of the memory card 1 might, e.g., comply with the specifications according to the SD card standard.

FIG. 2 shows a plan view of a bottom surface of a memory card 1 according to one embodiment of the invention. The bottom surface of the memory card 1 is made of resin resulting from the molding process at a stage of the fabrication process of the memory card 1, except for contact elements 9. A row of contact elements 9 is situated in the vicinity of the first edge 21 of the memory card 1. The contact elements 9 allow to establish a direct electrical contact to the memory card 1. A card reader device having electrical contacts and being configured to communicate with the memory card 1 through establishing a direct electrical contact to the memory card 1 can be used to read data from the memory card 1 and write data to the memory card 1. The number, the dimensions and the position of the contact elements 9 might be chosen to comply with standardized specifications of a multiplicity of various standard memory cards. The number, the dimensions and the position of the contact elements 9 might, e.g., be chosen to comply with the specifications for an SD card according to the SD card standard.

The memory card 1 may further include a mechanical write protect switch (not shown in FIG. 2). The write protect switch may have two positions; a write enable position and a write disable position. With the write protect switch being in the write enable position a suitable card reader device can write data to the memory card 1. With the write protect switch being in the write disable position, a suitable card reader cannot write data to the memory card 1.

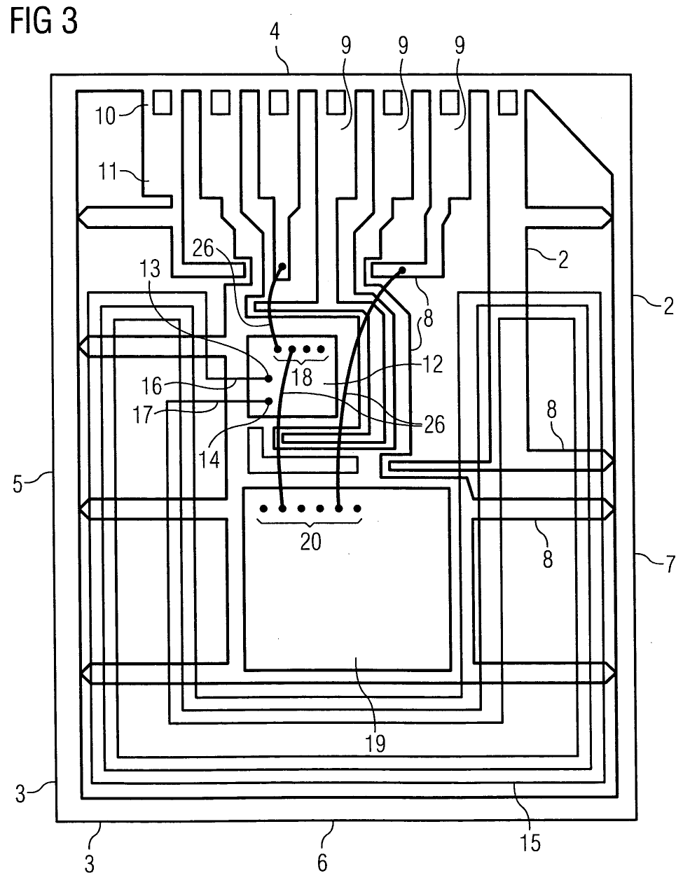

FIG. 3 shows schematically a plan view of a memory card 1 according to one embodiment of the invention during a stage of fabricating a memory card 1. A leadframe 2 acts as a substrate for the multiple components of a memory card 1. The material the leadframe 2 is made of might be a metal, preferably copper. The structure of the leadframe 2 may be fabricated from a metal sheet by a punching process. The leadframe 2 has a frame 3 that forms the first edge 4, the second edge 5, the third edge 6 and the fourth edge 7 of the leadframe 2.

The leadframe 2 has furthermore a multiplicity of leads 8 coupled to the frame 3. At the joints of the leads 8 with the frame 3, the leads are tapered to define a predetermined breaking point. The specific arrangement of the leads 8 depends on the design of the memory card 1 according to one embodiment of the invention.

The leadframe 2 has furthermore one or more contact elements 9. The contact elements 9 are situated in the vicinity of the first edge 4 of the frame 3 and have a first end 10 and a second end 11. The first ends 10 of the contact elements 9 are coupled to the first edge 4 of the frame 3. At the joint of the contact elements 9 and the leads 8, the leads 8 are tapered to define a predetermined breaking point. The second ends 11 of the contact elements 9 are coupled to at least a subset of the leads 8 of the leadframe 2. The number of the contact elements 9, the position and the dimension of the contact elements 9 may be adopted to a standard of a multiplicity of common memory cards.

A chip 12 is connected to at least a subset of the leads 8. The chip 12 has a first contact 13 and a second contact 14. The first contact 13 of the chip 12 and the second contact 14 of the chip 12 are located on a top surface of the chip 12. Alternatively, the first 13 and the second 14 contacts of the chip 12 could be located on a bottom surface of the chip 12. Additionally, the chip has further contacts 18 located on the top surface. Alternatively, these contacts 18 of the chip 12 could be located on the bottom surface of the chip 12. Another chip 19 is connected to at least a subset of the leads 8. The other chip 19 has contacts 20 that are located on the top surface of the other chip 19. Alternatively, the contacts 20 could be located on a bottom surface of the chip 12.

The chip 12 and the other chip 19 are positioned in a center region of the leadframe 2, the chip 12 being closer to the first edge 4 of the frame 3, the other chip 19 being closer to the third edge 6 of the frame 3. Other positions of the chip 12 and the other chip 19 on the leads 8 are possible. The chip 12 and the other chip 19 may also be positioned in the vicinity to an edge of the leadframe 2. The chip 12 and the other chip 19 might be mounted to the leads 8 through a glue. The chip 12 and the other chip 19, respectively, might be electrically insulated from the leads 8. Alternatively, the chip 12 and the other chip 19, respectively, might be electrically coupled to at least a subset of the leads 8. The chip 12 and the other chip 19 form a center region of the leadframe 2.

An antenna 15, configured for sending and/or receiving electromagnetic waves, is located on the leads 8 between the center region of the leadframe 2 and a second edge 5, a third edge 6 and a fourth edge 7 of the frame 3. A first end 16 of the antenna 15 is connected to the first contact 13 of the chip 12 and a second end 17 of the antenna 15 is connected to the second contact 14 of the chip 12 thereby forming a conductive connection between the antenna 15 and the chip 12. The antenna 15 is electrically isolated from the leads 8.

The antenna 15 may include an electrically conductive wire encapsulated with a non-conducting material to effect electrical isolation of the antenna 15 from the leads 8. Alternatively, an electrically conducting wire laminated between two non-conducting foils preferably made of plastic may form the antenna 15. The wire could be deposited onto a foil through a printing technique, through electrodeposition of strip lines, or another suited technique. However, the resistivity of the antenna 15 should be below a certain value to ensure sufficient sensitivity to electromagnetic waves.

As depicted, the antenna 15 has three loops. Alternatively, the antenna 15 might have at least one loop or three to eight loops. Alternative positions of the antenna 15 on the leadframe 2 are possible. The antenna 15 may, e.g., be wound around the center region of the leadframe 2 in the vicinity of the first edge 4, the second edge 5, the third edge 6 and the fourth edge 7 of the frame 3, thus increasing the coupling of the antenna 15 to a remote electromagnetic field. Preferably, the loops of the antenna 15 enclose a large area thus enabling the reception of signals with low intensity. Different arrangements of the antenna are possible, including the arrangement in single or multiple layers.

Some of the further contacts 18 of the chip 12 are connected to some of the leads 8 by wire leads 27 and some of the contacts 20 of the other chip 19 are connected to some of the leads 8 by wire leads 27. The chip 12 and the other chip 19 might be connected through those leads 8 to which a contact of the chip 12 and a contact of the other chip 19 has been established by wire leads 27. Alternatively, some of the further contacts 18 of the chip 12 could be connected to some of the contacts 20 of the other chip 19 through wire leads.

The chip 12 could be configured as controller chip and the other chip 19 could be configured as a memory chip, wherein the chip 12 is configured to perform access to the other chip 19 for data to be applied to the contact elements 9 or retrieved from the contact elements 9. Additionally, the chip 12 can be configured to perform access to the antenna 15 for one of sending and receiving of electromagnetic waves through the antenna 15. The chip 12 and the antenna 15 could be designed for one of sending and receiving of an electromagnetic wave that has a carrier frequency of 13.56 MHz.

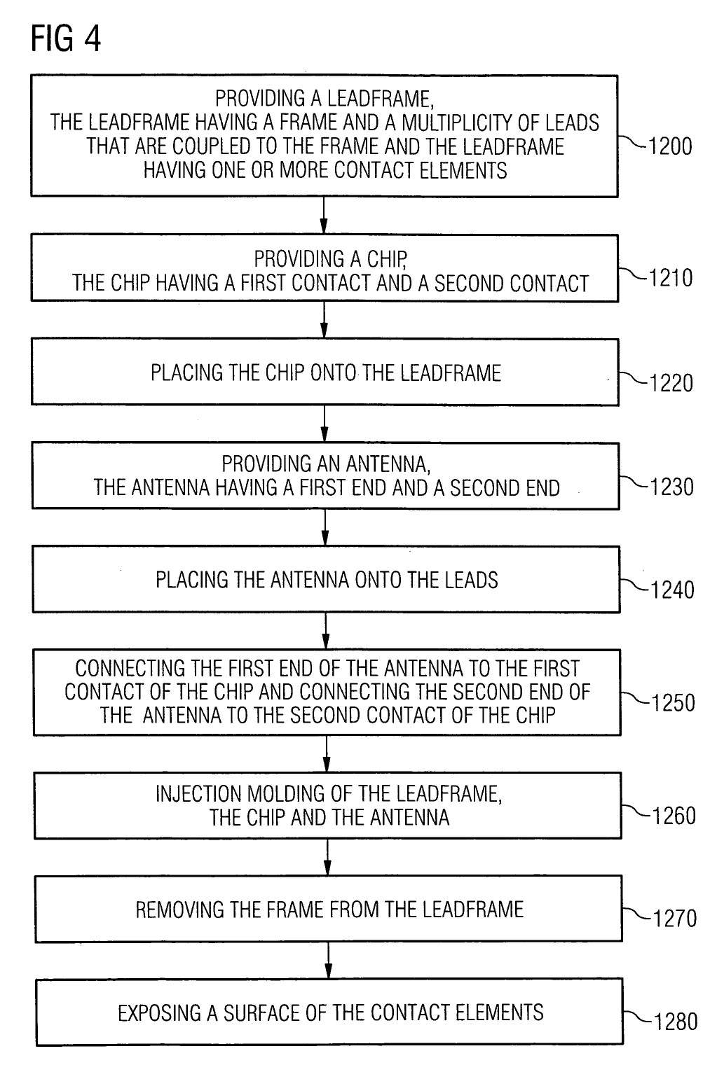

FIG. 4 shows a schematic of a process flow for fabricating a memory card 1 according to one embodiment of the invention. In a first step 1200 of the fabrication process of a memory card 1 a leadframe 2 is provided. The leadframe 2 has a multiplicity of leads 8 that are coupled to the frame 3 and one or more contact elements 9. The leadframe 2 is fabricated from a metal sheet, the metal sheet preferably being made of copper, through a punching process. Alternatively, the leadframe 2 can be obtained through structuring the metal sheet by applying a laser beam, a water beam or by using a suited etchant. The leadframe 2 may be included in a carrier band that includes a multiplicity of leadframes 2.

In step 1210 of the fabrication process of a memory card 1, a chip 12 that has a first contact 13 and a second contact 14 is provided. The first contact 13 and the second contact 14 of the chip 12 are located on a top surface of the chip 12. Alternative locations of the first contact 13 and the second contact 14 of the chip 12 may be realized.

In step 1220, the chip 12 is placed onto the leadframe 2. Therefore, a glue is applied to a subset of the leads 8, onto which the chip 12 is supposed to be mounted. Then, the chip 12 is put onto the leads 8 applied with the glue. After a certain period of time the chip is mechanically fixed to a subset of the leads 8.

An antenna 15 is provided in step 1230 of the fabrication process of a memory card 1 The antenna 15 has at least one loop and a first end 16 and a second end 17. The antenna 15 is further configured to one of sending and receiving electromagnetic waves. The conducting antenna 15 may be completely encapsulated with a non-conducting material. Preferably the antenna 15 is enamel-insulated. Alternatively, the first end 16 and the second end 17 of the antenna 15 are not encapsulated.

The antenna 15 is placed onto the leads 8 of the leadfrane 2 in step 1240, thereby insulating the antenna 15 from the leads 8. The antenna 15 may be fixed to the leads 8 through a suited technique.

In step 1250, the first end 16 of the antenna 15 is soldered to the first contact 13 of the chip 12 and the second end 17 of the antenna 15 is soldered to the second contact 14 of the chip 12. Thus, an electrical connection between the first 16 and the second 17 ends of the antenna 15 and the first 13 and the second 14 contacts of the chip 12 is established. Alternative to the soldering process, a welding process or other suited processes could be utilized to form the electrical connections.

In step 1260, the chip 12, the antenna 15 and the leadframe 2 are molded. The molding material is a resin that is preheated up to a certain temperature at which the resin is in liquid form, and at which the resin has a certain viscosity. The chip 12, the antenna 15 and the leadframe 2 are placed into a molding cavity that is preheated and designed to be impermeable for the resin, but permeable for air. Then the resin is injected into the molding cavity thereby filling the space between the molding cavity and the chip 12, the antenna 15, and the leadframe 2. The temperature of the molding cavity supports the flow of the resin into corners and edges of the mold. After the resin has become solid, the molded package, including the chip 12, the antenna 15 and the leadframe 2, is removed from the molding cavity.

In step 1270, the frame 3 is removed from the leadframe 2 through a punching process. Preferably leads 8 do not protrude from the molded package after the punching process has been performed.

In step 1280, a surface of the contact elements 9 is exposed through a punching process.

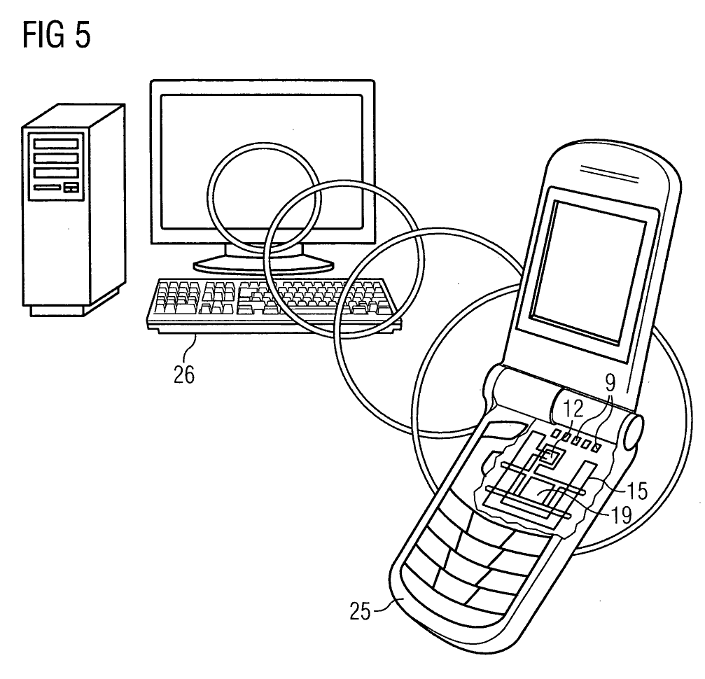

FIG. 5 depicts an example for an application of the memory card 1, namely a mobile phone apparatus 25. The mobile phone apparatus 25 is provided in a phone housing as shown and includes a user interface, which in this example includes a display 29 and an input mechanism, e.g., keyboard 30. Although not shown in the figure, the mobile phone apparatus also includes a receiver/transmitter unit for receiving telephone signals, a processor for manipulating those signals and an audio user interface, e.g., a microphone and a speaker.

The mobile phone apparatus 25 is equipped with a memory card 1 according to one embodiment of the invention. The memory card 1 is preferably contained in a slot located in the interior of the housing of the mobile phone apparatus 25. The slot preferably urges the memory card 1 in a determined position in the mobile phone apparatus 25. Being in that determined position, the contact elements 9 of the memory card 1 abut contacts of the mobile phone apparatus 25. Therefore, an electrical connection between the contact elements 9 of the memory card 1 and the contacts of the mobile phone 25 apparatus is established, thus enabling data transmission between the mobile phone apparatus 25 and the memory card 1. The memory card 1 can have the functionality of a standard GSM card. The mobile phone apparatus 25 can also be equipped with a microcontroller and a software configured to play back audio files. With such a configuration the mobile phone apparatus 25 could play back audio files stored on the memory card 1. Furthermore, the mobile phone apparatus 25 can be equipped with a microcontroller and a software configured to view pictures or to play back movie files stored on the memory card 1 on the display 29 of the mobile phone apparatus 25.

The memory card 1 contained in the housing of the mobile phone apparatus 25 furthermore includes a chip 12, another chip 19, an antenna 15 and leads 8, wherein the chip 12 and the antenna 15 are configured for sending and receiving of electromagnetic waves. Thus, non-contact data transmission between a suited reader/writer device 26 and the memory card 1 can be effected, once the mobile phone apparatus 25 including the memory card 1 is in vicinity of the reader/writer device 26. The reader/writer device 26 and the memory card 1 can be equipped with a processor or a chip 12 that is configured to encrypt and decrypt data. For authentication purposes data identifying the specific memory card 1 may be stored in encrypted form on the chip 12 of the memory card 1. A reader/writer device 26 having a matching key can decrypt the encrypted data stored on the memory card 1, thereby identifying the memory card 1. Non-contact transmission of data between the reader/writer device 26 and the memory card 1 can be utilized for a multiplicity of applications. One application of this authentication process is that a door lock opens upon bringing the memory card 1 into the vicinity of a reader/writer device 26. Preferably this feature could be suited for mass transport applications, wherein data transmission must be performed very quickly, because the memory card 1 does not have to be introduced into a slot of a memory card reader.

It is to be understood, that this invention is not limited to the particular component parts of the devices described or to process steps of the methods described as such devices and methods may vary. It is also to be understood, that different features as described in different embodiments, for example illustrated with different figures, may be combined to new embodiments. It is finally to be understood, that the terminology used herein is for the purposes of describing particular embodiments only and it is not intended to be limiting. It must be noted, that as used in the specification and the appended claims, the singular forms of “a”, “an”, and “the” include plural referents until the context clearly dictates otherwise.

What is claimed is:

1. A method of fabricating a memory card, the method comprising:
providing a leadframe, said leadframe having a frame, a multiplicity of leads coupled to said frame and having one or more contact elements;
providing a chip, said chip having a first contact and a second contact;
placing said chip onto said leadframe;
providing an antenna, said antenna having at least one loop and said antenna being configured to one of receive and send electromagnetic waves and said antenna having a first end and a second end;
placing said antenna onto said leads of said leadframe, thereby electrically insulating said antenna from said leads;
coupling said first contact of said chip to said first end of said antenna and coupling said second contact of said chip to said second end of said antenna;
injection molding of said leadframe, said chip and said antenna;
removing said frame from said leadframe; and
exposing a surface of said contact elements.

2. The method of claim 1, wherein said step of providing a leadframe includes providing said leadframe having said frame having a first edge, a second edge, a third edge and a fourth edge, wherein said second edge and said fourth edge of said frame are longer than said first edge and said third edge of said frame.

3. The method of claim 2, wherein said step of providing a leadframe includes providing said leadframe having said frame, having said one or more contact pads that are situated in proximity to said first edge of said frame.

4. The method of claim 2, wherein said step of providing a leadframe includes providing said leadframe, having said one or more contact pads that have a first end and a second end, said first end of said one or more contact pads coupled to said first edge of said frame and said second end of said one or more contact pads coupled to at least a subset of said leads.

5. The method of claim 2, wherein said step of placing said antenna onto said leads of said leadframe includes placing said antenna onto said leads between said chip and at least one of said second edge, said third edge and said fourth edge of said frame.

6. The method of claim 1, wherein said step of providing a chip includes
providing a chip that has further contacts and
coupling at least a subset of said further contacts of said chip to at least a subset of said leads.

7. The method of claim 1, further comprising:
providing a second chip, said second chip having contacts;
placing said second chip onto said leadframe;
coupling at least a subset of said contacts of said second chip to at least a subset of said leads; and
coupling the chip and the second chip for data transmission between the chip and the second chip.

8. The method of claim 7, wherein said step of providing a chip includes providing a chip being configured as a controller chip to perform access to said second chip for data to be applied to said contact elements or retrieved from said contact elements and to perform access to said antenna for one of sending and receiving of electromagnetic waves through said antenna.

9. The method of claim 7, wherein said step of injection molding comprises placing said leadframe, said antenna, said chip and said second chip into a molding cavity, then injection molding said leadframe, said antenna, said chip and said second chip with resin, and then removing the molded package from said molding cavity.

10. The method of claim 9, wherein said step of providing a second chip includes providing a second chip that is configured as a memory chip to perform digital data storage.

11. The method of claim 10, wherein said step of providing a second chip includes providing a second chip that is configured as a memory chip including an array of non-volatile and erasable memory cells to perform digital data storage.

12. The method of claim 1 1, wherein said memory chip includes an array of memory cells having a capacity for digital data storage of at least one Gigabyte.

13. The method of claim 1, wherein said leadframe is made of metal.

14. The method of claim 13, wherein said leadframe comprises copper.

15. The method of claim 1, wherein said antenna includes at least three loops.

16. The method of claim 1, wherein said antenna includes between three and eight loops.

17. A memory card comprising:
a multiplicity of leads;
one or more contact elements;
a chip, said chip being coupled to at least a subset of said leads, said chip having a first contact and a second contact; and
an antenna placed on said leads, said antenna being electrically isolated from said leads, said antenna having a first end and a second end, said antenna having at least one loop and said antenna being configured to one of receive and send electromagnetic waves;
wherein said first contact of said chip is coupled to said first end of said antenna and wherein said second contact of said chip is coupled to said second end of said antenna;
wherein said leads and said chip and said antenna are molded; and
wherein a surface of said contact elements is exposed.

18. The memory card of claim 17, wherein said memory card has a first edge, a second edge, a third edge, a fourth edge and a fifth edge.

19. The memory card of claim 18, wherein said one or more contact elements are situated in proximity to said first edge of said memory card.

20. The memory card of claim 19, wherein said antenna is placed on said leads between said chip and said second edge, said third edge and said fourth edge of said memory card.

21. The memory card of claim 17, wherein said chip has further contacts and at least a subset of said further contacts being coupled to at least a subset of said leads.

22. The memory card of claim 17, further comprising a second chip, said second chip being coupled to at least a subset of said leads and said second chip having contacts, wherein at least a subset of said contacts of said second chip is coupled to at least a subset of said leads, and wherein said chip and said second chip are coupled for data transmission between said chip and said second chip.

23. The memory card of claim 22, wherein said chip is configured as a controller chip to perform access to said second chip for data to be applied to said contact elements or retrieved from said contact elements and to perform access to said antenna for one of sending and receiving of electromagnetic waves through said antenna.

24. The memory card of claim 23, wherein said second chip is configured as a memory chip to perform digital data storage.

25. The memory card of claim 24, wherein said memory chip is configured as a memory chip including an array of non-volatile and erasable memory cells to perform digital data storage.

26. The memory card of claim 25, wherein said memory chip includes an array of memory cells having a capacity for digital data storage of at least one Gigabyte.

27. The memory card of claim 26, wherein said leads are made of metal.

28. The memory card of claim 27, wherein said leads comprise copper leads.

29. The memory card of claim 17, wherein said antenna has at least three loops.

30. The memory card of claim 17, wherein said antenna has three to eight loops.

31. The memory card of claim 17, wherein said antenna and said chip are designed for one of sending and receiving of an electromagnetic wave having a carrier frequency of 13.56 MHz.

32. A mobile phone apparatus comprising:
a phone housing;
a display integrated in said phone housing;
an input mechanism integrated in said phone housing;
a receiver/transmitter unit for receiving telephone signals;
a processor coupled to the receiver/transmitter for manipulating the telephone signals;
an audio user interface coupled to the processor, each of the receiver/transmitter, the processor and the audio user interface being disposed within the phone housing; and
a memory card within the phone housing, the memory card being configured to perform contactless transmission of data between a reader/writer device and said memory card and perform data transmission between said mobile phone apparatus and said memory card, the memory card comprising:
a multiplicity of leads;
one or more contact elements;
a chip, said chip being coupled to at least a subset of said leads, said chip having a first contact and a second contact; and
an antenna placed on said leads, said antenna being electrically isolated from said leads, said antenna having a first end and a second end, said antenna having at least one loop and said antenna being configured to one of receive and send electromagnetic waves;
wherein said first contact of said chip is coupled to said first end of said antenna and wherein said second contact of said chip is coupled to said second end of said antenna;
wherein said leads and said chip and said antenna are molded; and
wherein a surface of said contact elements is exposed.

33. The mobile phone apparatus of claim 32, wherein said memory card is configured to perform contactless transmission of data between said reader/writer device and said memory card through sending and/or receiving electromagnetic waves.

34. The mobile phone apparatus of claim 32, wherein said memory card includes an identifier and wherein said memory card is configured to perform contactless transmission of authentication data between said reader/writer device and said memory card through one of sending and receiving electromagnetic waves.

35. The mobile phone apparatus of claim 32, wherein said memory card includes a processor that is configured to encrypt and decrypt data and wherein said memory card is configured to perform contactless transmission of encrypted data between said reader/writer device and said
